(19) United States
(12) Patent Application Publication
(10) Pub. No.: US 2008/0118903 A1
(43) Pub. Date: May 22, 2008

(54) Publishing medium having unique inserts

(76) Inventor: Robin Johnson, Rancho Murieta, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 11/603,927

(22) Filed: Nov. 21, 2006

(51) Int. Cl. B42D 1/00

(52) U.S. Cl. 434/317

(57) ABSTRACT

An apparatus and methods for publishing printed matter, whereby information relevant to the story is made available to the reader in a tangible form to enhance the reader's experience or understanding of the story. The invention generally comprises tangible, life-like indicia or inserts which add an element of surprise and/or intrigue when a reader comes across or locates the insert. The insert may provide evidence or further corroborate or add credibility to the story to engage the reader.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C. F. R. §1.14.

### BACKGROUND OF THE INVENTION

1. Field of the Invention

This invention pertains generally to publishing printed matter, and more particularly printed matter having inserts to enhance the reader's experience.

2. Description of Related Art

Printed publications, such as books, magazines, etc. generally comprise a series of printed sheets or pages of paper bound within a cover. Generally, very little extra is provided to enhance the readers experience other than the printed text or illustrations. In recent years, pop-ups have been used to add dimension to the story, but generally are merely 3-D illustrations of some aspect of the story. Pop-ups don't add realism, and are traditionally reserved for children's texts.

Photographs added to various pages of the text may add some elements of realism, but also are merely illustrations of aspects of the story.

Accordingly, an object of the invention is to provide a bound publication tangible indicia to enhance the storyline and reader's experience.

### BRIEF SUMMARY OF THE INVENTION

An aspect of the invention is a published work (e.g. book, magazine, etc.), having a publishing medium having a plurality of pages of text that form a story. The published work has an insert, or plurality of inserts, configured to be disposed within the publishing medium. Each of the inserts comprise an object that is a life-like reproduction of a physical entity, such as a theatre ticket, handwritten note, claim check, etc., that relates to an aspect of the story to enhance a reader's a reading experience upon viewing the object.

The object may be referred to in the story, or not be discussed in the story, but rather provide additional information in support of the story.

In one embodiment, the insert is configured to be located between two of the pages of the work. Preferably, the location of the insert is predetermined (by the author, editor or like individual) to correspond to a timeline of the story.

In another embodiment, the insert comprises one of the plurality of pages configured such that the object is attached to the page.

In a further embodiment, the published work comprises a book having a binding configured to hold the plurality of pages, and the insert comprises a planar sheet having a binding edge disposed in the binding within the plurality of pages, such that the object comprises at least a portion of the planar sheet.

Preferably, the object has material properties distinct from the bound pages, e.g. is has a different thickness, texture or composition.

In an alternative embodiment, the object is releasably attached to the publishing medium so that it could be removed by the reader.

Preferably, the insert comprises a means for concealing the object until desired to be viewed by the reader. For example, the object may be covered in shrink-wrap or other enclosure material that may be removed by the reader when desired.

Another aspect of the invention is an insert for a bound publication. The insert comprises a planar sheet configured to be disposed within the publishing medium. A physical object is coupled to the planar sheet, wherein the object comprises a life-like reproduction of a physical entity that relates to an aspect of the story to enhance a reader's a reading experience upon viewing said physical object.

The planar sheet may be configured to be located on the inside cover of the book, or between two pages at a predetermined location that corresponds to a timeline of said story. Alternatively, the planar sheet may comprise one of the pages of the bound publication, with the object attached to the insert page. The physical object may also be configured to be concealed within the bound publication until it is desired to be viewed by the reader.

A further aspect of the invention is method of publishing a bound work. The method includes the steps of providing a manuscript comprising a story; and identifying subject matter that relates to an aspect of the story from the manuscript that is conducive to physical representation in planar form. The method further includes fabricating an insert comprising a physical reproduction of the subject matter, and inserting the subject matter within the bound work.

In one embodiment, the method also includes identifying a location along the timeline of the story where disclosure of the subject matter is desired, and locating the subject matter at a page in the bound work that corresponds to the identified location.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 illustrates a perspective view of a book having an information-bearing insert in accordance with the present invention.

FIG. 2 is a perspective view of a book having a detachable insert in accordance with the present invention.

FIG. 3 is a plan view of the detachable insert of FIG. 2 prior to insertion in a book.

FIG. 4 illustrates a perspective view of a book having an insert comprising a bound page in accordance with the present invention.

FIG. 5 shows the insert of FIG. 4 with a cover over a portion of the insert.

FIG. 6 illustrates a perspective view of a book having an envelope-type insert disposed within the book binding.

FIG. 7 is a plan view of the insert of FIG. 6 prior to insertion in a book.

FIG. 8 illustrates a perspective view of a book having an folded insert disposed within the book binding.

FIG. 9 is a plan view of the insert of FIG. 8 prior to insertion in a book.

FIG. 10 illustrates a book enclosure device in accordance with the present invention.

FIG. 11 illustrates an alternative book enclosure device in accordance with the present invention.

### DETAILED DESCRIPTION OF THE INVENTION

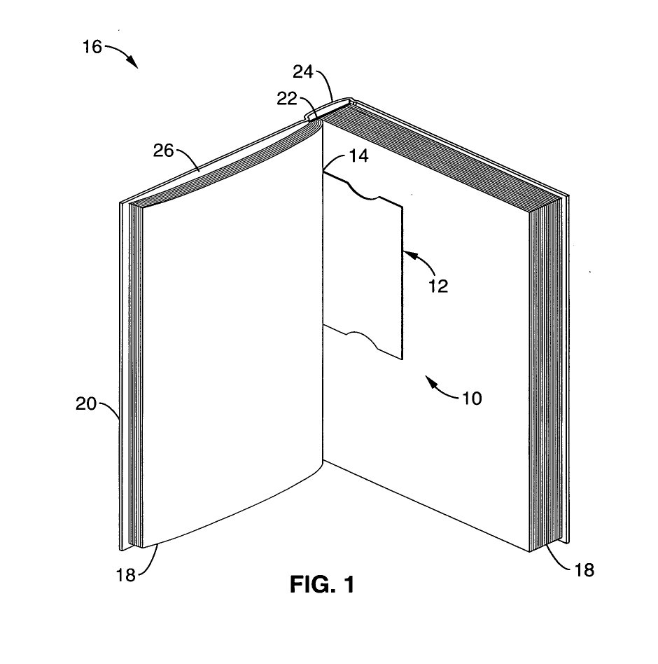

Referring more specifically to the drawings, for illustrative purposes the present invention is embodied in the apparatus generally shown in FIG. 1 through FIG. 11. It will be appreciated that the apparatus may vary as to configuration and as to details of the parts, and that the method may vary as to the specific steps and sequence, without departing from the basic concepts as disclosed herein.

The present invention includes apparatus and methods for publishing printed matter wherein information relevant to the story or focus of the printed matter is made available to the reader in a tangible form to enhance the reader's experience or understanding of the story. The invention generally comprises tangible, life-like indicia or inserts which add an element of surprise and/or intrigue when a reader comes across or locates the insert. The insert may provide evidence or further corroborate or add credibility to the story to engage the reader in ways not available with existing publishing methods.

Referring to FIG. 1, a book 16 in accordance with the present invention is shown having an insert 10 disposed between pages 18 or cover 20 of the book. The insert 10, may comprise a physical object 12, which is shown as a movie ticket for exemplary purposes only. The physical object 12 is generally planar, and generally comprises a life-like reproduction of a physical entity that one may experience in real life.

The insert 10 may be configured to comprise a number of different tangible objects relating to the book. Preferably, the insert 10 is generally planar shaped to allow for practical placement within the pages of the book. For example, the insert 10 may comprise a retail purchase receipt, coat claim, handwritten letter by one of the characters, dry cleaning ticket, theatre ticket or sporting ticket, ribbon, fabric, credit card, personal check, or like object that relates to the content of the bound work.

The insert 10 may also comprise a variety of different material characteristics to distinguish it from the pages 10 of the book 16. For example, insert 10 may comprise card stock, vellum, cloth, or paper having a different texture or thickness than the bound pages 18. It may also have a different thickness or texture that the pages of the book.

The insert 10 is configured to provide information or evidence that relates intimately to an aspect of the story to add depth, realism and reader engagement. The evidence may relate to aspects of the story that are of particular significance to the author and the message, plot, or theme that the author is trying to convey. The evidence provided by the insert 10 may be specifically mentioned in the book, or may not be mentioned, but may rather provide additional insight or information, essentially providing a different medium for communicating the author's message.

The insert 10 may be inserted or bound to the book via a number of techniques generally available in the art. For example, for books having a binding 22 running along the spine 24 of the book 16, the insert may be positioned at a certain location within the pages 18 of the book 16. For example the insert may be located at a particular spot in the text, and oriented such that a binding edge 14 is flush with the binding edges of the text pages 18, so that the insert is bound with pages 18 into binding 22.

Alternatively, insert 10 may not be physically attached to the book 16, In some cases, insert 10 may be inserted manually or through a ‘blow in’ in a somewhat random location between pages 18, as opposed to gluing, tacking, or otherwise binding the tangible indicia as a less costly way to insert clues of light weight (like a mock receipt, etc.).

The insert 10 may be specifically positioned by the author as to the proper location in the book, e.g. between pages 158 and 159. This may provide a timing element to the dispensing of information at a time in the story that is preferred by the author. For example, the author may want to reveal to the reader, as a predetermined point along the storyline, that a first character was in the vicinity of a second character during a pivotal event. In this example, the insert 10 may comprise a sporting event ticket with the first character's name on it, and the seat location that puts the first character in eyesight of the second character.

The insert 10 may also comprise information that leads the reader to an external source (e.g. website, reference book, etc.) that provides additional clues or insight in to the story.

It is also contemplated that the book 16 may comprise a plurality of inserts 10 disposed between various pages of the book according to the timeline set by the author.

Alternatively, the insert 10 may be positioned on the inside surface 26 of the front cover 20. In this configuration, the insert 10 may act as a prologue to the story.

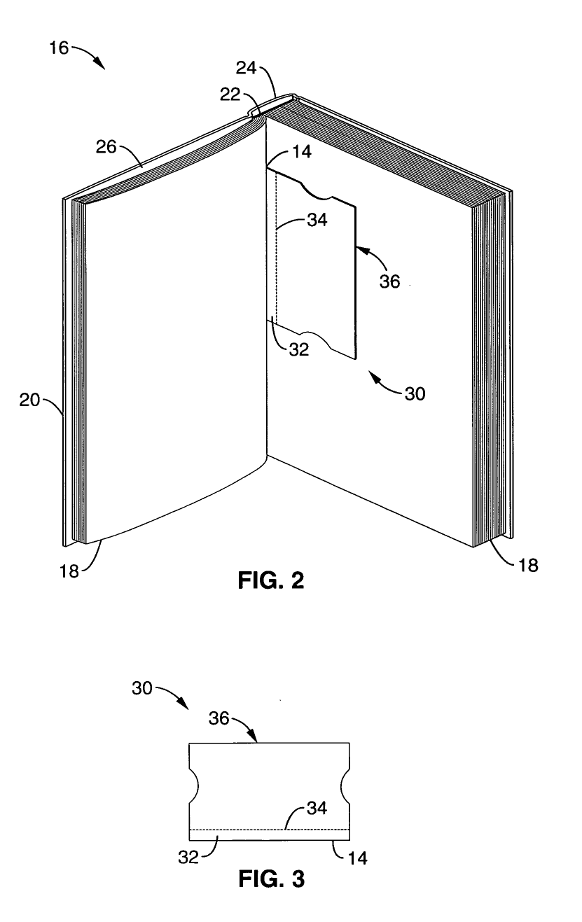

Referring to FIG. 2, an alternative insert 30 may be used that allows the evidence or object 36 to be removed from the binding 22. FIG. 3 illustrates insert 30 before insertion in book 16. The insert 30 comprises a perforation line 34 separating a binding panel 32 having binding edge 32 from object (ticket) 36. Thus, when the reader gets to the particular location in the book where the insert 30 is located, the object 36 may be pulled along the perforation line 34 to remove it from the book 16. This allows object 36 to be used for other purposes, such as a bookmark, or the like.

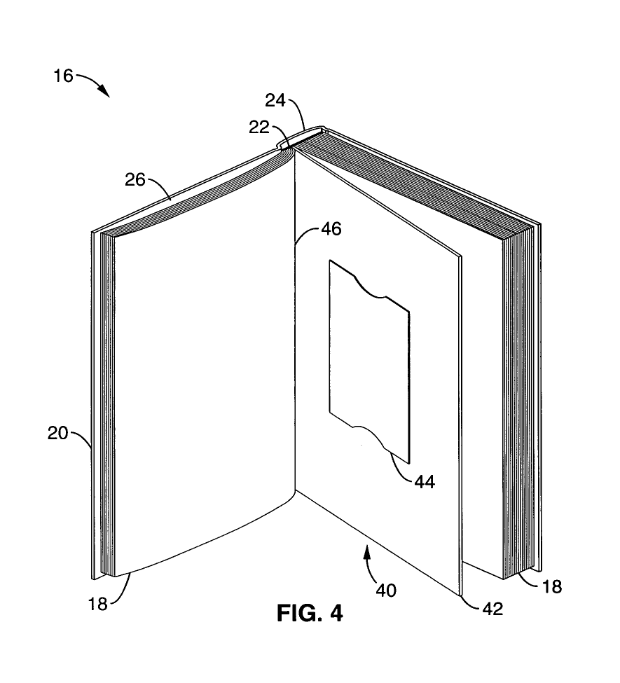

FIG. 4 illustrates an alternative insert 40 in accordance with the present invention. Insert 40 may comprise a bound page 42 of the book 16 at the location in the book determined by the author. The object 44 of interest relating to the story is attached to the bound page via an adhesive, staple, clip, or other fastening means. Where desired, a drop of low tack adhesive may be used to secure object 44 to the page 42, so that the object 44 may be removed for the page 42 if desired. The page 42 may be blank, or have text that surrounds object 44. Page 42 has a binding edge 46 so that is can be bound flush with the remainder of pages 18 into binding 22.

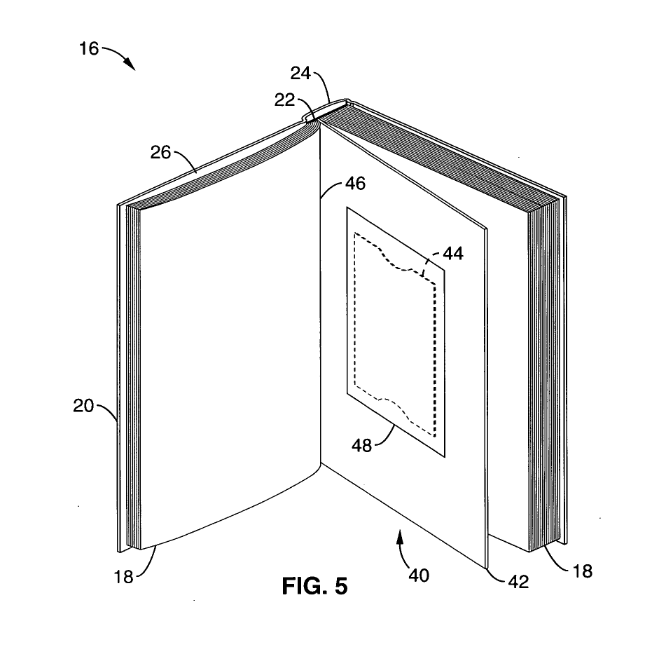

Because the object 44 may delineate the pages it is between, it may have the effect of drawing the reader to the object 44 prior to the reader actually arriving to the location in the book via reading. In cases where the information or subject matter of the object 44 is time sensitive, i.e. specifically designated to be revealed at a certain point along the timeline, the object 44 may be concealed or enclosed from the reader's view. In one embodiment shown in FIG. 5, a cover 28 comprising a sheet of paper or the like, may be disposed over the object 44. Cover 48 may be fastened to the page 42 via a low tack adhesive, or other easily removable fastener known in the art.

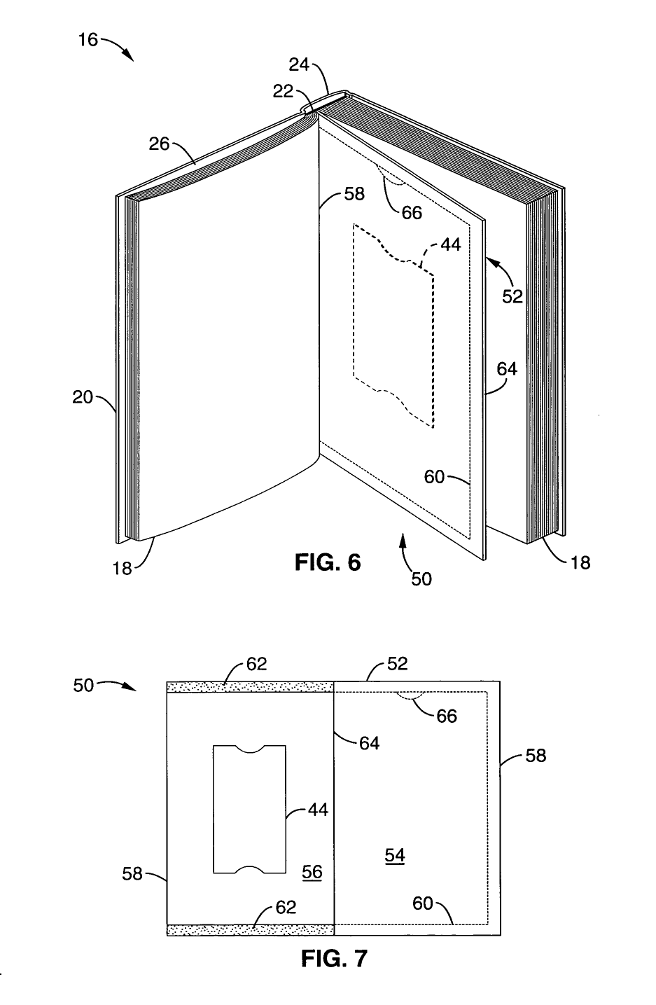

FIGS. 6 and 7 illustrate yet another alternative insert 50 in accordance with the present invention. Insert 50 is also configured to hide the presence of information provided on evidence or object 44. In this embodiment, the insert 50 comprises an elongate sheet of paper 52 that is generally two times as wide as a text pages 18. Sheet 52 is configured to be folded along fold line 64 so that the object may be positioned between faces 54 and 56 of the sheet. Adhesive strips 62 may be placed along the top edges of panel 56 to adhere panel 56 to panel 54. Panel 54 is perforated with perforation 60 and finger notch 66 so that the reader may pull back part of panel 54 expose the object 44 at the proper time. When the sheet is folded over, binding edges 58 are positioned flush with respect to one another so that the insert 50 may be bound into binding 22.

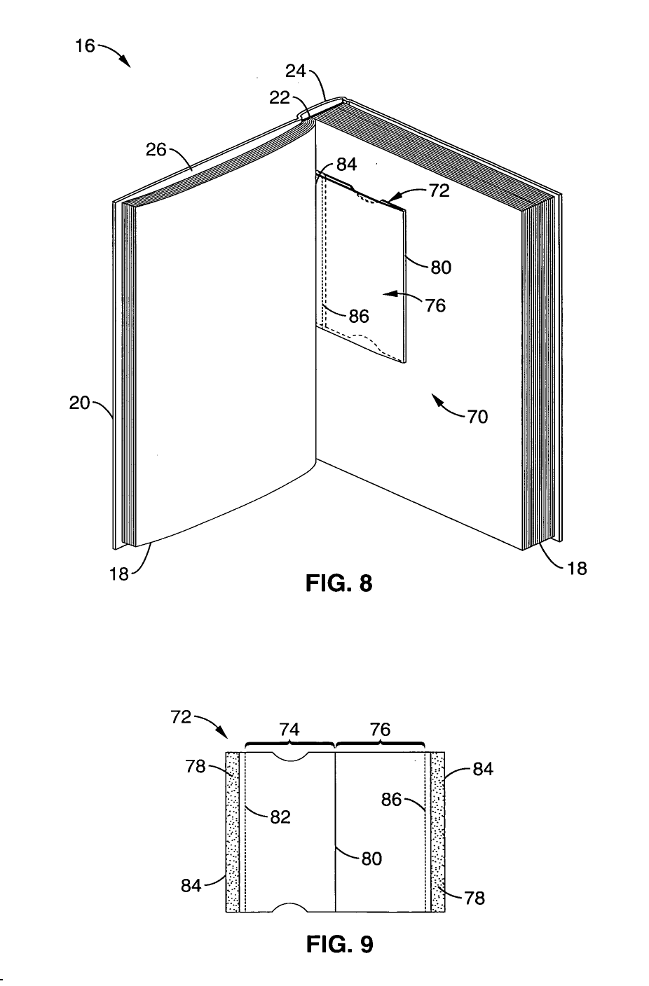

FIGS. 8 and 9 illustrate a further embodiment of an insert 70 in accordance with the present invention. Insert 70 comprises a planar sheet 72, a part of which comprises the object 74 of particular interest to the story. The sheet 72 is folded about fold line 80 prior to insertion into binding 22, such that panel 76 covers the contents of object 74. Adhesive 78 may be provided along binding edges 84 to secure the ends of panels 74 and 76 together. Alternatively, the edges 84 may be bound into binding 22 without adhesive, essentially using the binding to secure the panels shut. A perforation 86 may be provided to allow the cover panel 76 to be opened by the reader, thereby exposing the contents of object 74 at the appropriate time. Perforation 82 and a perforation along the fold line 80 may also be provided to separate the object 74 entirely.

The object 74 may also be shrink wrapped with a colored plastic or the like to cover or conceal the contents therein. Envelopes, or similar packaging systems may also be incorporated into the binding or on particular pages of the book.

In the method of the present invention an author may write a story with or without the intention of placing predetermined evidence or storyline related objects within the book. Once the manuscript is written, certain evidence or other information are identified that add depth, realism and/or reader engagement to the story. The evidence may or may not be mentioned in the book. For example, a private note between or about characters may not be included in the manuscript, and it may be preferred to do so, so that the reader does not read the same material twice. Next the location of the information bearing objects within the book and storyline are determined. Each object is then evaluated to determine the best method of fabrication and insertion (e.g. packaging) into the book to maintain authenticity and also keep manufacturing reasonable.

Different versions of the inserted evidence may also be provided so as to provide a unique experience among different readers. For example, the evidence may 1) be mentioned in the manuscript, 2) not be mentioned in the manuscript, but obviously be associated with the manuscript, or 3) not be provided at all. A random distribution within a lot of books may also be determined so that within one outlet all versions (no matter how many) would be represented.

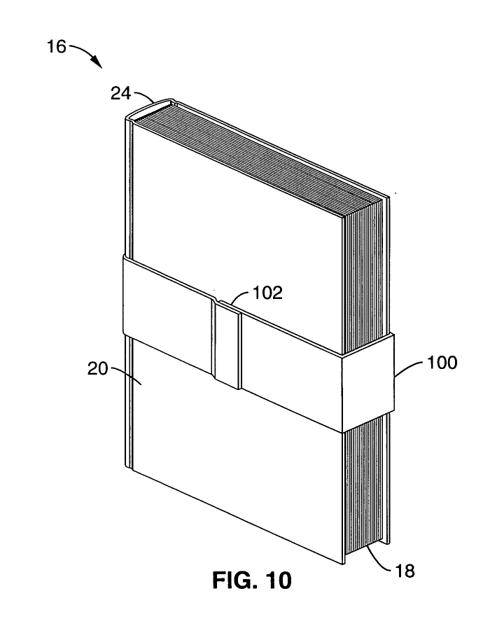

Referring now to FIG. 10. an enclosure device 100 may be used to keep the book closed until purchased, or opened by the reader. Enclosure device 100 may comprise a paper strip wrap that encircles the cover 20 of the closed book 16 so that it can't be opened inadvertently or prematurely. This mechanism might be used in order to prevent readers from seeking out in advance whether or not their copy has an additional ‘clue’ or not. To open the book, the reader must slide the enclosure 100 off the book, or separate ends 102 that may be tack-glued together.

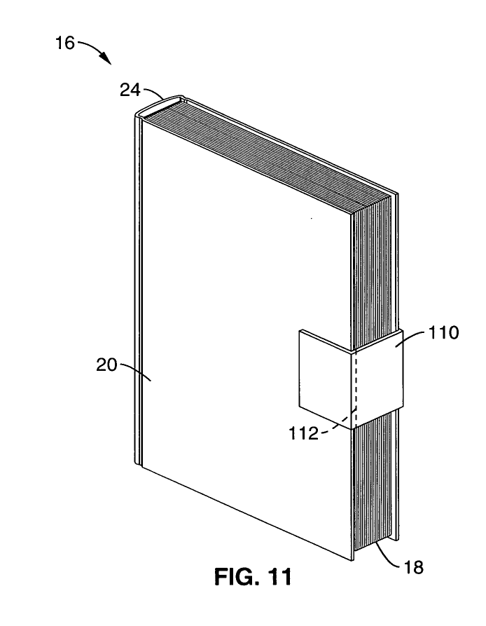

Referring to FIG. 11 a perforated tab closure, 110. Enclosure 110 may be adhered to the cover 20 of the book 16 via a low-tack adhesive or the like, and may have a perforation 112 that allows the enclosure 110 to be separated.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A published work, comprising:
a publishing medium;
wherein said publishing medium comprises a plurality of pages of text that form a story; and
an insert configured to be disposed within the publishing medium;
the insert comprising an object that is a life-like reproduction of a physical entity;
wherein the object relates to an aspect of the story to enhance a reader's reading experience upon viewing said physical object.

2. A published work as recited in claim 1:
wherein the object is referred to in the story.

3. A published work as recited in claim 1:
wherein the object is not referred to in the story, but provides additional information in support of the story.

4. A published work as recited in claim 1:
wherein the insert is configured to be located between two of the plurality of pages.

5. A published work as recited in claim 4:
wherein the location of said insert is predetermined to correspond to a timeline of said story.

6. A published work as recited in claim 1:
wherein the insert comprises one page of the plurality of pages of the publishing medium; and
wherein the object is attached to said one page.

7. A published work as recited in claim 1:
wherein the published work comprises a book having a binding;
the binding configured to hold the plurality of pages;
wherein the insert comprises a planar sheet having a binding edge disposed in the binding within the plurality of pages; and
wherein the object comprises at least a portion of the planar sheet.

8. A published work as recited in claim 1:
wherein the object has material properties distinct from the plurality of pages.

9. A published work as recited in claim 1:
wherein the object is releasably attached to said publishing medium such that the object can be removed from the publishing medium.

10. A published work as recited in claim 1:
wherein the insert comprises a means for concealing the object until desired to be viewed by the reader.

11. A published work as recited in claim 10:
wherein said means comprises shrink-wrap.

12. A published work as recited in claim 10:
wherein said means comprises an enclosure.

13. A published work as recited in claim 1, further comprising:
an enclosure releasably attached to the published work;
wherein the enclosure is configured to keep the published work closed until the enclosure is removed.

14. An insert for a bound publication having a plurality of pages of text that form a story, comprising:
a planar sheet configured to be disposed within the bound publication;
an object coupled to the planar sheet;
the object comprising a life-like reproduction of a physical entity;
wherein the object relates to an aspect of the story to enhance a reader's a reading experience upon viewing said physical object.

15. An insert as recited in claim 14:
wherein the object is referred to in the story.

16. An insert as recited in claim 14:
wherein the object is not referred to in the story, but provides additional information in support of the story.

17. An insert as recited in claim 14:
wherein the planar sheet is configured to be located between two of the plurality of pages.

18. An insert as recited in claim 17:
wherein the location of said planar sheet is predetermined to correspond to a timeline of said story.

19. An insert as recited in claim 14:
wherein the planar sheet comprises one page out of the plurality of pages of the bound publication; and
wherein the object is attached to said page.

20. An insert as recited in claim 14:
wherein the bound publication comprises a book having a binding;
the binding configured to hold the plurality of pages;
wherein the planar sheet comprises a binding edge disposed in the binding within the plurality of pages; and
wherein the object comprises at least a portion of the planar sheet.

21. An insert as recited in claim 20:
wherein the object is releasably attached to the binding such that the object can be removed from the bound publication.

22. An insert as recited in claim 14:
wherein the object is configured to be concealed until it is desired to be viewed by the reader.

23. A method of publishing a bound work, comprising:
providing a manuscript comprising a story;
identifying subject matter from the manuscript that is conducive to physical representation in planar form;
wherein the subject matter relates to an aspect of the story;
fabricating an insert comprising a physical reproduction of the subject matter;
inserting the subject matter within the bound work.

24. A method as recited in claim 23, further comprising:
identifying a location along the timeline of the story where disclosure of the subject matter is desired; and
locating the subject matter at a page in the bound work;
wherein said page corresponds to said identified location.

25. A method as recited in claim 24, wherein the subject matter is referred to in the story.

26. A method as recited in claim 24, wherein the subject matter is not referred to in the story, but adds additional information in support of the story.
